(19) United States
(12) Patent Application Publication
(10) Pub. No.: US 2006/0000334 A1
(43) Pub. Date: Jan. 5, 2006

(54) Component supplying device

(75) Inventors: Christianus A.G. Vroomans, Eindhoven (NL); Franciscus L. Vermeulen, Ah Eindhoven (NL); Joseph J.F. Mooren, Ah Eindhoven (NL)

Correspondence Address: FOLEY AND LARDNER LLP;SUITE 500, 3000 K STREET NW, WASHINGTON, DC, 20007, US

(73) Assignee: Assembleon N.V.

(21) Appl. No.: 10/516,515

(22) PCT Filed: May 21, 2003
(86) PCT No.: PCT/IB03/02320

§ 371 Date: Jul. 14, 2005

(30) Foreign Application Priority Data
Jun. 3, 2002 (EP) 02077165.5

(51) Int. Cl. B26D 5/12

(52) U.S. Cl. 83/605; 83/649

(57) ABSTRACT

A component supplying device includes a tape reel holder, in which a tape reel can be detachably positioned, and a tape supplying and discharging device. The component supplying device may furthermore include a cutting device that includes a knife that can be moved by means of a piston that is capable of performing a reciprocating movement within a cylinder.

The invention relates to a component supplying device provided with a tape reel holder in which a tape reel can be detachably positioned, and a tape supplying and discharging device.

A device known from EP-A1-0 918 453 comprises a component supplying device and a cutting device positioned below the former and provided with a knife that can be reciprocally moved.

Such a component supplying device is used in component placement devices which are known per se. Components are located in a tape which is built up, for example, from a carrier tape provided with compartments and a covering tape closing the compartments and thus enclosing the components. The tape wound on a reel is placed in a tape reel holder, whereupon the tape is indexed by the component supplying device until one of the compartments is situated above a component pick-up position. The covering tape has already been removed from the carrier tape prior to this. After a component has been removed from the tape by the component placement device, the empty carrier tape is discharged. The carrier tape is cut into small fragments then by a cutting device positioned below the component supplying device. This has the advantage that the carrier tape cut into fragments occupies a comparatively small volume.

The device known from the European patent application has the disadvantage, however, that the cutting device and the tape supplying device do not form an integral whole. As a result, tape coming from the component supplying device can only be cut up in those locations where the component placement device is provided with a cutting device.

The invention has for its object to provide a device in which the disadvantages of the known component supplying device are avoided.

This object is achieved in the device according to the invention in that a cutting device is located in the component supplying device.

The integration of the cutting device in the component supplying device renders it possible to cut any tape supplied by the component supplying device into fragments. In addition, any component placement device may be provided with a component supplying device with an integrated cutting device in this manner. It is thus made possible to place components by means of any existing component placement device, whereupon the tape from which the components were taken is cut into pieces.

An embodiment of the device according to the invention is characterized in that the cutting device comprises a knife which can be displaced by means of a piston which is reciprocally displaceable in a cylinder.

A knife can be driven in a comparatively simple manner by such a piston-cylinder combination. In addition, such a piston-cylinder combination has a comparatively compact construction. This compact construction renders it possible to implement the cutting device also in comparatively small component supplying devices.

A further embodiment of the device according to the invention is characterized in that the piston-cylinder combination extends at an angle to the displacement direction of the knife, while a transmission is located between the piston-cylinder combination and the knife. The transmission renders it possible to have the piston-cylinder combination extend, for example, substantially horizontally, whereas the knife is displaceable in a vertical direction. The cutting device can be constructed in a comparatively compact manner as a result of this.

An alternative embodiment of the device is that the cylinder is a pneumatic cylinder.

An advantage of such a device is that only a limited amount of space is occupied if the pneumatic cylinder is of a compact shape.

The invention will be explained in more detail below with reference to the accompanying drawing, in which:

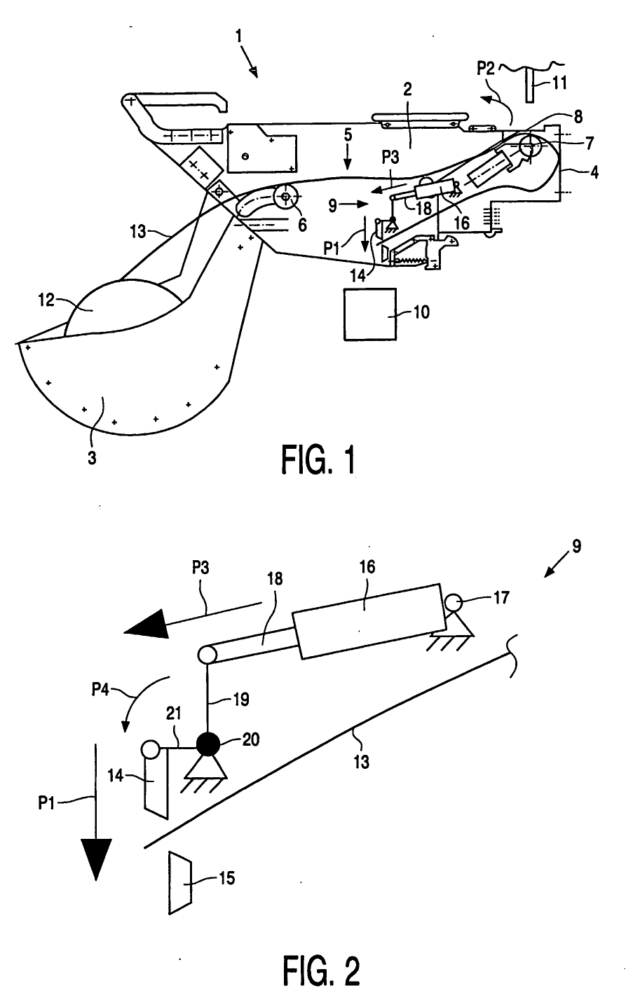

FIG. 1 is a cross-sectional view of an embodiment of the component supplying device according to the invention, and

FIG. 2 shows the cutting device of FIG. 1 on an enlarged scale.

Corresponding components have been given the same reference numerals in the Figures.

FIG. 1 shows a component supplying device 1 which is provided with a frame 2. A tape reel holder 3 is fastened to one side of the frame 2, and a fastening 4 is situated at the other side for detachably fastening the component supplying device to a component placement device (not shown) which is known per se. A tape supplying and discharging device 5 comprising transport rollers 6, 7 is located between the fastening 4 and the tape reel holder 3. A component pick-up position 8 is located at the upper side of the frame 2 adjacent the fastening 4. A pipette 11 of a component placement device (not shown) is depicted above the component pick-up position 8. A cutting device 9 connected to the frame 2 is situated in the component supplying device 1 below the tape supplying and discharging device 5. A waste bin 10 is furthermore placed below the component supplying device 1.

A detachable tape reel 12, around which a tape 13 is wound, is present in the tape reel holder 3. The tape 13, which is known per se, comprises a carrier tape provided with compartments and a covering tape closing the compartments. Components are situated in the compartments. The tape 13 is transported over the transport rollers 6, 7 by means of geared wheels (not shown).

The cutting device 9 (see FIG. 2) comprises two mutually opposed knives 14, 15. The knife 14 is displaceable in and opposite to the direction indicated by arrow P1. The knife 15 is fixedly positioned. The cutting device 9 further comprises a cylinder 16 whose one end is pivoted to the frame 2 by means of a hinge 17. A piston 18 is present in the cylinder 16 and is connected to an end of a link 19 of a transmission. The link 19 is hinged to the frame 2 by means of a hinge 20. The link 19 is fixedly connected to a second link 21 of the transmission, which link 21 is hinged to the displaceable knife 14 at an end remote from the hinge 20.

The operation of the component supplying device 1 will now be explained in more detail.

The tape 13 is transported from the tape reel 12 through the tape supplying and discharging device 5 by means of the transport roller 6. The covering tape is removed from the tape before the component pick-up position 8 and is discharged in a direction indicated by arrow P2. This causes a component to lie freely in the compartment of the carrier tape, so that it can be picked up from the compartment by the pipette 11 in the component pick-up position 8. The empty carrier tape 13 is displaced further over the transport roller 7 towards the cutting device 9. The carrier tape 13 is passed between the displaceable knife 14 and the stationary knife 15 in the cutting device 9. Activation of the piston-cylinder combination displaces the piston 18 in the direction indicated by arrow P3, so that the links 19, 21 of the transmission are pivoted about the pivot point 20 in the direction indicated by arrow P4. This displaces the knife 14 in the direction indicated by arrow P1 along the knife 15, whereby the carrier tape 13 present between them is cut off. The cut-off piece of carrier tape drops into the waste bin 10.

It is obviously also possible to drive the knife 14 not with a piston-cylinder combination but by means of a linear motor, an electric drive possibly in combination with a power accumulator, etc.

1-5. (canceled)

6. A component supplying device comprising:
a tape reel;
a tape reel holder in which the tape reel is detachably positioned;
a cutting device provided in the component supplying device; and
a tape supplying and discharging device configured to transport tape from the tape reel to the cutting device.

7. The component supplying device according to claim 6, further comprising:
a cylinder; and
a piston that is reciprocally displaceable in the cylinder,
wherein the cutting device comprises a knife that is displaceable by means of the piston.

8. The component supplying device according to claim 7, wherein the cylinder is a pneumatic cylinder.

9. The component supplying device according to claim 7, wherein the piston-cylinder combination extends at an angle to a displacement direction of the knife.

10. The component supplying device according to claim 7, further comprising:
a transmission located between the piston-cylinder combination and the knife.

11. The component supplying device according to claim 10, wherein the transmission comprises an element that is pivotable about an axis of rotation.

12. The component supplying device according to claim 11, wherein an end of the knife and an end of the piston are fastened to the element such that the knife and the piston are separately pivotable about axis.

13. The component supplying device according to claim 12, wherein the element comprises a first link connected to the end of piston and a second link connected to the end of the knife.

14. The component supplying device according to claim 13, wherein the first link is substantially perpendicular to the second link.

15. The component supplying device according to claim 13, wherein the first and second links are joined at the axis of rotation.

16. A component supplying device comprising:
a tape reel;
a tape reel holder in which the tape reel is detachably positioned;
a cylinder;
a piston that is reciprocally displaceable in the cylinder;
a cutting device provided in the component supplying device, the cutting device comprising a knife that is displaceable by means of the piston; and
a tape supplying and discharging device configured to transport tape from the tape reel to the cutting device.

17. The component supplying device according to claim 16, wherein the cylinder is a pneumatic cylinder.

18. The component supplying device according to claim 16, wherein the piston-cylinder combination extends at an angle to a displacement direction of the knife.

19. The component supplying device according to claim 16, further comprising:
a transmission located between the piston-cylinder combination and the knife.

20. The component supplying device according to claim 19, wherein the transmission comprises an element that is pivotable about an axis of rotation.

21. The component supplying device according to claim 20, wherein an end of the knife and an end of the piston are fastened to the element such that the knife and the piston are separately pivotable about axis.

22. The component supplying device according to claim 21, wherein the element comprises a first link connected to the end of piston and a second link connected to the end of the knife.

23. The component supplying device according to claim 22, wherein the first link is substantially perpendicular to the second link.

24. The component supplying device according to claim 22, wherein the first and second links are joined at the axis of rotation.
